(19) United States
(12) Patent Application Publication
(10) Pub. No.: US 2014/0214550 A1
(43) Pub. Date: Jul. 31, 2014

(54) System and Method for Communicating Targeted Health Related Data

(71) Applicant: Marketing Technology Solutions, Jersey City, NJ (US)

(72) Inventors: Robert P. Costanzo, New York, NY (US); Paul E. Cimino, Stockholm, NJ (US)

(73) Assignee: Marketing Technology Solutions, Jersey City, NJ (US)

(21) Appl. No.: 14/168,698

(22) Filed: Jan. 30, 2014

Related U.S. Application Data
(63) Continuation of application No. 12/370,858, filed on Feb. 13, 2009, now abandoned.
(60) Provisional application No. 61/028,310, filed on Feb. 13, 2008.

(51) Int. Cl. G06Q 30/02

(52) U.S. Cl. CPC G06Q 30/0269
USPC 705/14.66

(57) ABSTRACT

The present invention provides a system and a method for communicating targeted health related data. The method includes targeting the consumers with an advertisement content and registering the consumers upon the selection of the advertisement. The registering includes capturing and storing the personal profile and health related data of the consumer and/or member(s) of this household. The method further includes processing the stored data to provide the consumer with the targeted content relevant to the consumer. The method further includes retrieving additional healthographic profiling of the consumer and the activity of the consumer to and further processing with the stored data to provide the consumer with an advertisement content targeted to the consumer and/or member(s) of his/her household.

This application claims priority to U.S. Provisional Application No. 61/028,310, filed Feb. 13, 2008, the disclosure of which is hereby incorporated by reference in its entirety.

### FIELD OF THE INVENTION

The present invention relates generally to a method for communicating health related data targeted to a consumer, and, more particularly, to systems and methods for ongoing tracking and analysis of consumer profile and health care behavior in order to provide relevant content tailored to the consumer.

### BACKGROUND OF THE INVENTION

The advent of networked communications, and in particular communications via the Internet, has radically changed the way consumers interact with suppliers of goods and services. This new model of commerce, often called e-commerce, includes how consumers investigate a particular product or service they wish to purchase, how suppliers advertise their wares to their target customer base and how the transaction between the consumer and the supplier is consummated. Where as previously consumer purchases were generally limited to those suppliers in the consumer's geographic area or remotely accessible, for example, via mail-order, the Internet has widened the consumer's buying opportunities to literally any supplier in the world. The consumer can now search the Internet for a product or service that meets the consumer's needs and purchase it from the supplier that offers the best deal.

Similarly, the Internet has changed the way suppliers of goods and services advertise in an effort to expand their customer base. Instead of being restricted to the high cost, inflexible and geographically limited print, radio and television advertisement mediums, the Internet has enabled advertisers to reach millions of potential customers using tools such as bulk e-mail and banner advertisements. Now, for little to no cost, suppliers can target a potential customer base that spans the globe.

Although access to a global e-commerce network opens up a wide range of opportunities for consumers and suppliers alike, there are several key deficiencies in the e-commerce model, especially in the health market, as it currently exists. Firstly, it is very often difficult for the consumer to find relevant and useful information about the health related product and or service that the consumer would like to purchase and also difficult to find a suitable supplier of the product and/or service. The Internet search engine technology that is typically used to find such information generally provides hundreds of URLs in response to a query—far too many for the consumer to review and many of which that are not relevant to the consumer. Secondly, it is often difficult for the suppliers to obtain important and relevant health related information about the consumers for the suppliers to provide the best suitable product and/or service to the consumer. Thirdly, many internet based advertising schemes have drawbacks such that they generally provide consumers with health related advertisements in which the consumer has not generated any real interest in.

Thus, there is a need for an improved method and system for tracking and analyzing consumer profiles and health care behavior in order to provide relevant content tailored to the consumer.

### SUMMARY OF THE INVENTION

Embodiments of the present invention are directed to a system and method for registering targeted health related data. The method includes providing a consumer with an advertisement and upon the consumer's selection of the advertisement, registering the consumer's personal profile and health care data.

Embodiments of the present invention also provide for a system and method for communicating the targeted health data to the consumer. The method includes processing the consumer's personal profile and health related data to provide the consumer with the content relevant to the consumer. Such content may include, but is not limited to, health news, medical information, health polls, advertisements, etc.

Embodiments of the present invention further provide for a system and method for providing the consumer with a health related advertisement targeted to the consumer. The method includes retrieving additional healthographic profiling of the consumer and the activity of the consumer, and further processing with the consumer's personal profile and health related data to provide the consumer with an advertisement content relevant to the consumer.

In certain embodiments, the present invention is directed to a system for communicating targeted health related data comprising: an entity server comprising a database; a source server associated with a source of health related data which is transmitted to the entity server; a consumer device which transmits personal information to, and receives health related data from, the entity server; wherein the entity server assigns a score to the personal information received from the consumer device and transmits health related data to the consumer device depending on the score assigned.

In other embodiments, the present invention is directed to a method for communicating health related data to a consumer comprising: providing the consumer with access to a entity server via a consumer device; gathering personal information from the consumer in the entity server; gathering health related data from a source server; assigning a score to the personal information; providing health related information to the consumer determined by the score assigned to the personal information.

In preferred embodiments, the health related data is selected from the group consisting of: savings on products or services, advertisements, information on health related conditions, articles, recipes, information on health care professional, and combinations thereof.

In preferred embodiments the consumer data profile contains information selected from the group consisting of a consumer name, a consumer mailing address, a consumer e-mail address, a consumer healthographic profile, a consumer transaction history, and combinations thereof.

As used herein, the term “a” or “an” can mean more than one.

### BRIEF DESCRIPTION OF THE DRAWINGS

The present invention will be more readily understood from the detailed description of exemplary embodiments presented below considered in conjunction with the attached drawings, of which:

FIG. 1 is a schematic block diagram of a system for communicating targeted health data in accordance with an embodiment of the present invention;

FIG. 2 is a flow diagram of a method for communicating targeted health data with the embodiment of the present invention;

FIGS. 3A through 3D illustrate screen images of various exemplary advertisements content in accordance with an embodiment of the present invention;

FIGS. 4A through 4D illustrate screen images of various exemplary landing pages content in accordance with another embodiment of the present invention;

FIGS. 5A through 5F illustrate screen images of exemplary registration pages content in accordance with even another embodiment of the present invention;

FIGS. 6A through 6D illustrate screen images of exemplary homepages content in accordance with further embodiment of the present invention.

It is to be understood that the attached drawings are for purposes of illustrating the concepts of the invention.

### DETAILED DESCRIPTION OF THE INVENTION

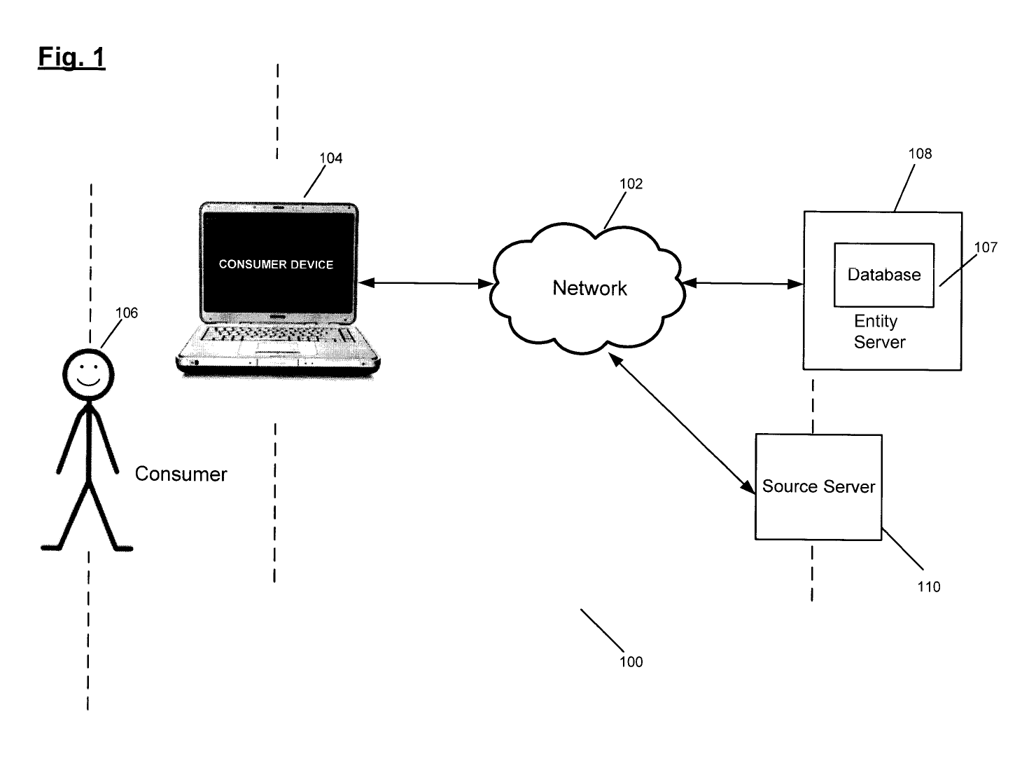

Referring to FIG. 1 of the present invention, there is shown a block diagram of a system 100, for communicating targeted health related data in accordance with an embodiment of the present invention. The system includes a network 102, which may be any communications medium, preferably, but not limited to, the Internet. Also included in the system is a plurality of consumer devices 104 operated by a plurality of consumers 106, and each of which being in communication with the network 102 as shown. Consumer devices 104 can be any device that allows connection to a network 102 including, but not limited to, a personal computer containing, for example, a modem and executing communications software. Where network 102 is the Internet, consumer device 104 could, for example, communicate with network 102 using web browser software. In an exemplary embodiment, consumer device 104 is a mobile device (for example a, hand held device) that communicates with network 102 via a wireless connection.

The system further includes at least one entity server 108 connected to the network 102 as shown in FIG. 1. The entity server 108 includes a central processor that executes a computer program that performs the functions of a relevant content algorithm, which will be described below. The entity server 108 also includes a communications device, for example a modem, for connecting to the network 102. Once, the entity server 108 and the communications devices 104 connect to the network 102, the entity server 108 and the consumer devices 104 can freely communicate with each other via network 102.

A plurality of different source (partner/publisher) servers 110 associated with a plurality of sources (not shown), are also connected to the network 102, preferably to be in communication with the entity server 108. The sources are external entities such as media partners or publishers which communicate via the source servers 110. Each of the source servers 110 are identified by their unique source identification (SID). The entity server 108 includes a database 107 of information relating to the product and/or services offered by the sources. In the preferred embodiment such information includes content on health data, which may include, but is not limited to savings on products and/or services, advertisements, health related conditions, articles, recipes, information on health professionals, etc. The entity server 108 further functions to assign publisher ID (PID) to all of the sources that communicate with the entity server 108 via the source server 110.

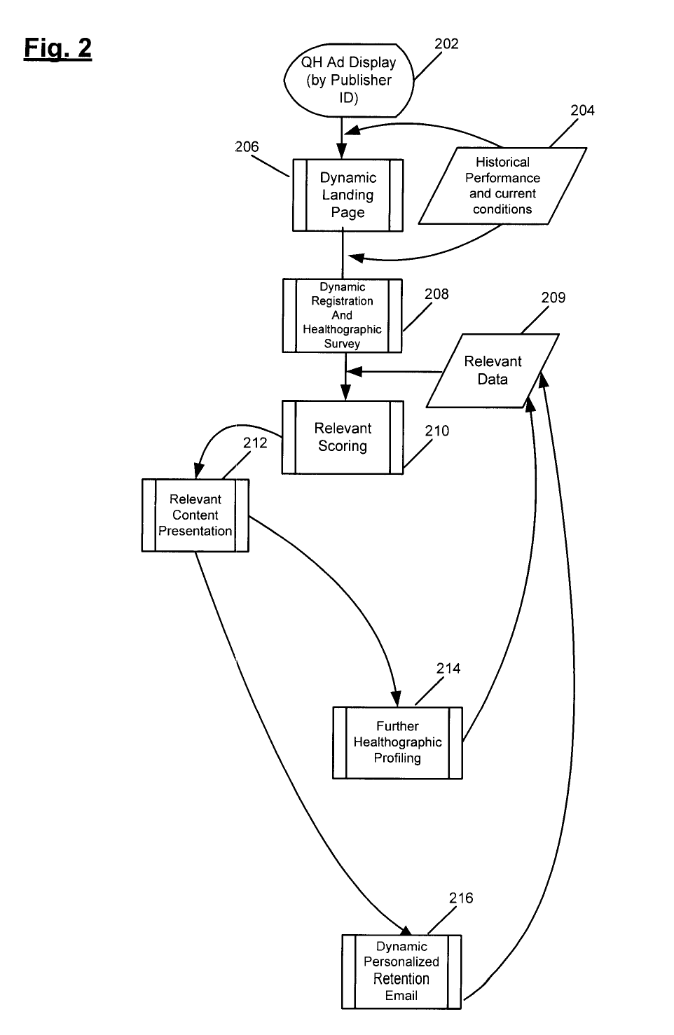

Referring to FIG. 2 of the present invention, there is provided a flow diagram of a method for registering targeted health related data utilizing the elements of FIG. 1 in accordance with one embodiment of the present invention. Initially, in step 202, at least one advertisement (ad) is presented on the consumer device 104 via the network 102. Each ad is uniquely identified by referring publisher identification ID (ND), which identifies the source (SID) that provided the ad via the source server 110. The ads with their corresponding PIDs, i.e. PID/ad combination are stored in a database of the entity server 108. The ads communicated to the consumers 106 are preferably chosen based on their value propositions. These value propositions are determined by the processor of the entity server 108 based on the yield/conversion information gathered by the entity server 108. In other words, the entity server 110 will obtain a count of number of times each ad was selected by the consumer 106 and obtain a value proposition for that ad based on the count. The entity server 108 dynamically supplies these value propositions to their corresponding network source servers 110 to help the network sources determine the optimal ad/SID combination.

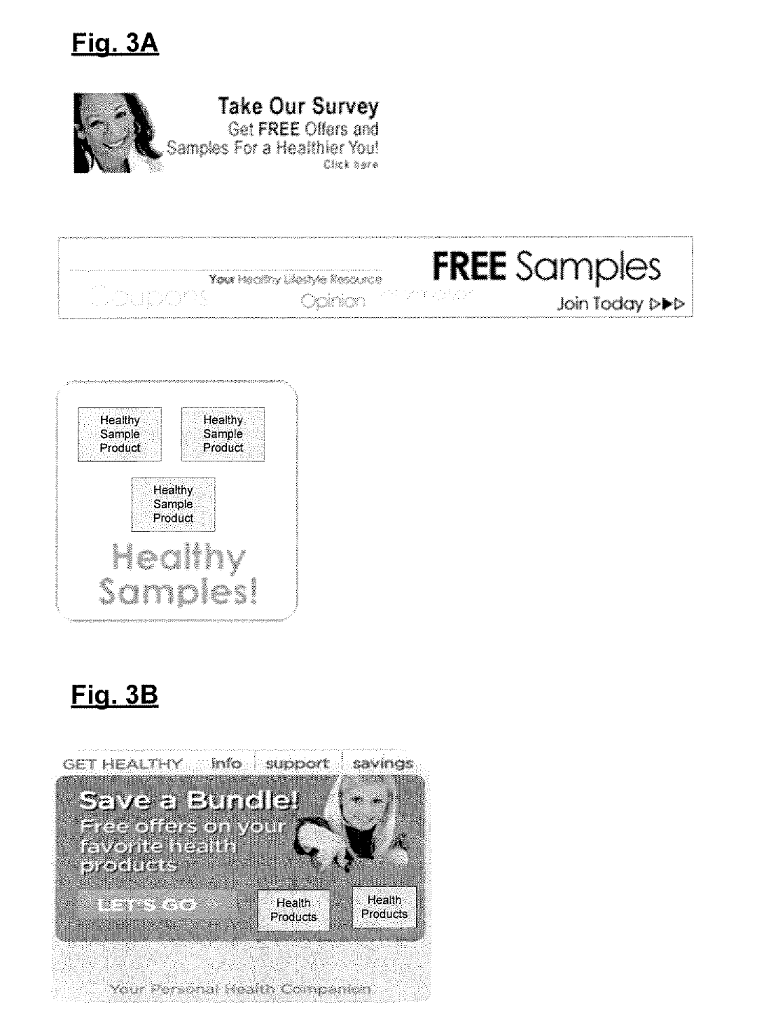

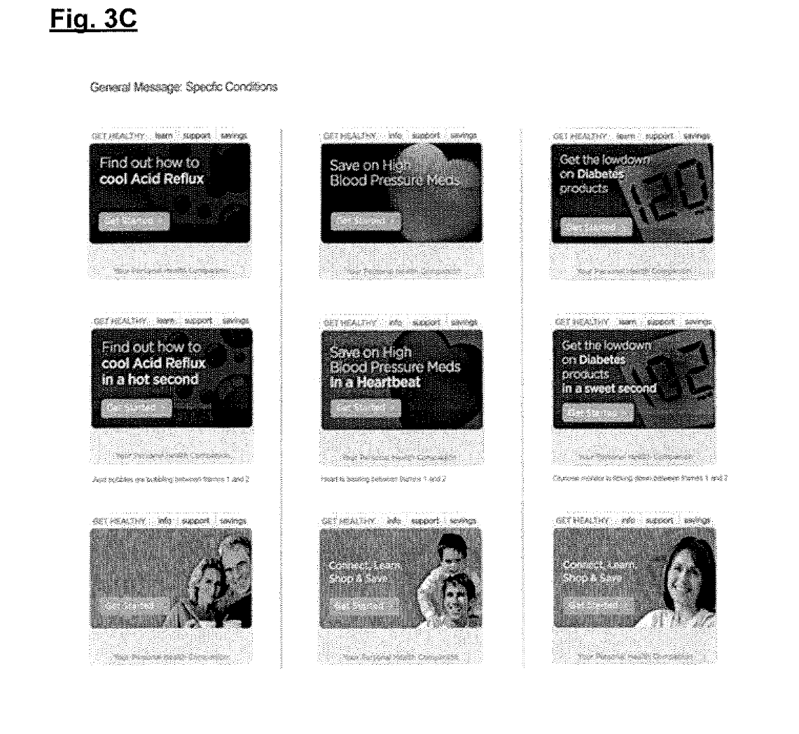

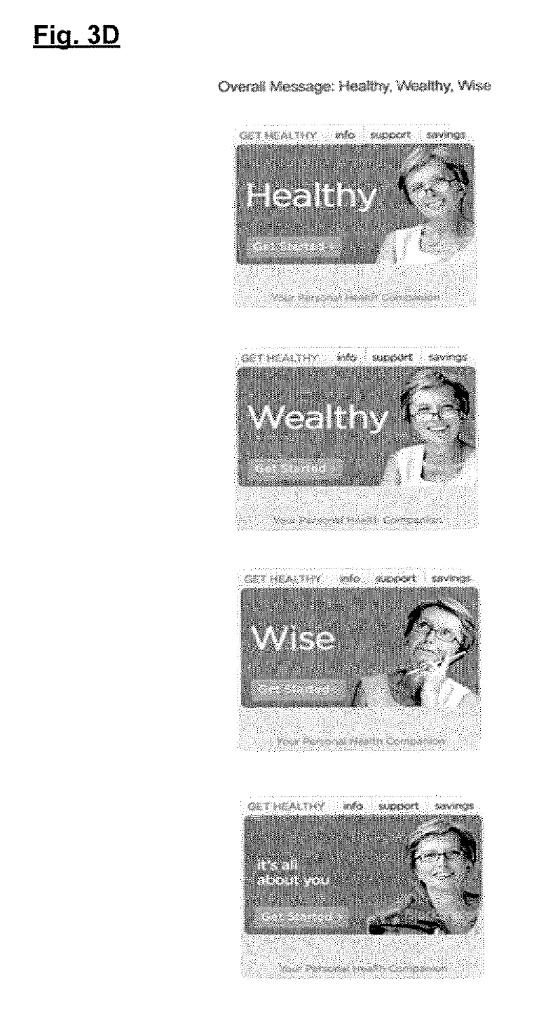

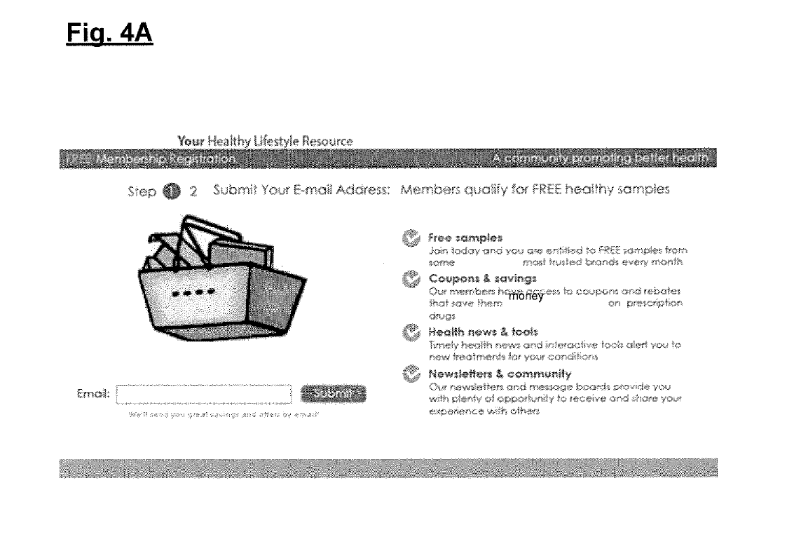

The ad preferably includes content related to health data, for example, promoting quality health. The ad may preferably be communicated to the consumer 106 via an e-mail sent to the consumer device 104 by the source server 110. Alternatively, the ad may be desirably displayed directly on the internet of the consumer device 104 of the consumer 106 who has communicated with the entity server 108 via the network. Some examples of the variety of these advertisements (ads) communicated to the consumers 106 to promote quality health with different value propositions are illustrated in FIG. 3A, FIG. 3B, FIG. 3C and FIG. 3D. As shown in FIGS. 3A and 3B, the ads are savings related, i.e. providing free offers, coupons, samples and products related to health and/or personal care. Other ads as shown in FIG. 3C are condition related. In other words, providing general health related information or specific health related information, including shopping and savings on health products and/or services. Furthermore, some ads as shown in FIG. 3D, relate to the overall message, exemplary, healthy, wealthy and wise.

The consumer 106 preferably selects one or more of the ads displayed, which prompts the entity server 108 to check the historical performance and current conditions of the consumer 106 at step 204. This step 204 preferably includes searching the database 107 to determine if a data profile exists for that consumer 106. The data profile preferably includes, but is not limited to name, USPS validated mailing address, email address, healthographic profile (conditions suffered, etc.), and transaction history (offers taken, etc.). As is known in the art, once the consumer 106 clicks on the ad, the consumer 106 is identified, based on “cookies”, upon consumer's access to the entity server 108. If a data profile exists for that consumer 106, then the entity server 108 establishes that this consumer is a member of the entity server 108. In this case, the entity server 108 may leverage the relevant data 209. The details of the relevant data 209 will be described in greater detail below.

Whether, the consumer data profile exists or not for that consumer 106, or alternatively, to allow the consumer 106 to re-register, at step 208, the entity server 108 will execute to process and communicate a landing page at step 206 on the consumer device 104 of that consumer 106 via the network 102. Based on the ad selected by the consumer 106, the entity server 108 will execute the relevant content algorithm to identify each of the PID/ad combination in the database, and dynamically select and link the consumer device 106 to the landing page, thus optimizing consumer flow. This selection of the landing page is based on several factors. One such factor is registration rate, i.e. the percentage of consumers who joined the membership of the entity server 108 as a result of creative. Creative simply means the images and/or the description of the ad (banner) pages, the landing pages. Another factor is life time value (LTV) of the consumer to entity server 108 in monetary units. The LTV means the gross dollar amount that is earned by the entity server 108 in a given period of time. The LTV calculation for a source (SID) is the average amount of dollars made from the consumers driven from that SID to a specific landing page creative. Note that the LTV is the aggregated value based on all the consumers (already members of the entity server) from the same source (SID). This is the key metric for businesses as it demonstrates both consumer interest and effectiveness of the business, i.e., its ability to monetize consumer's time and usage of the entity server (i.e., website). Another factor is cost of acquisition, i.e., the amount of monetary units paid by the entity server 108 to the source for the membership/registration in the entity server 108. The cost of acquisition will preferably cause the entity server 108 to select the questions/information to ask the consumer 106 on the landing pages.

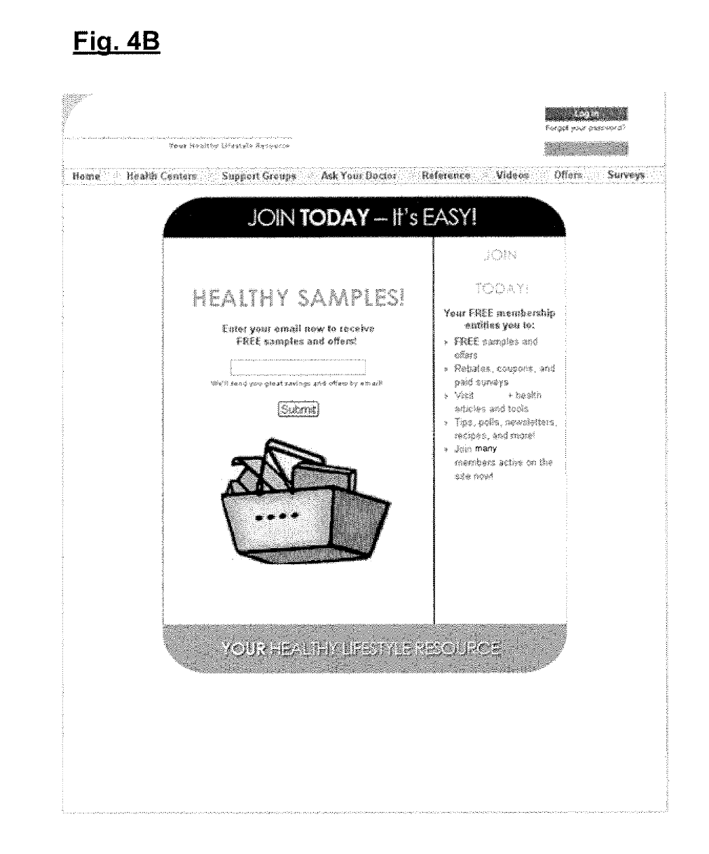

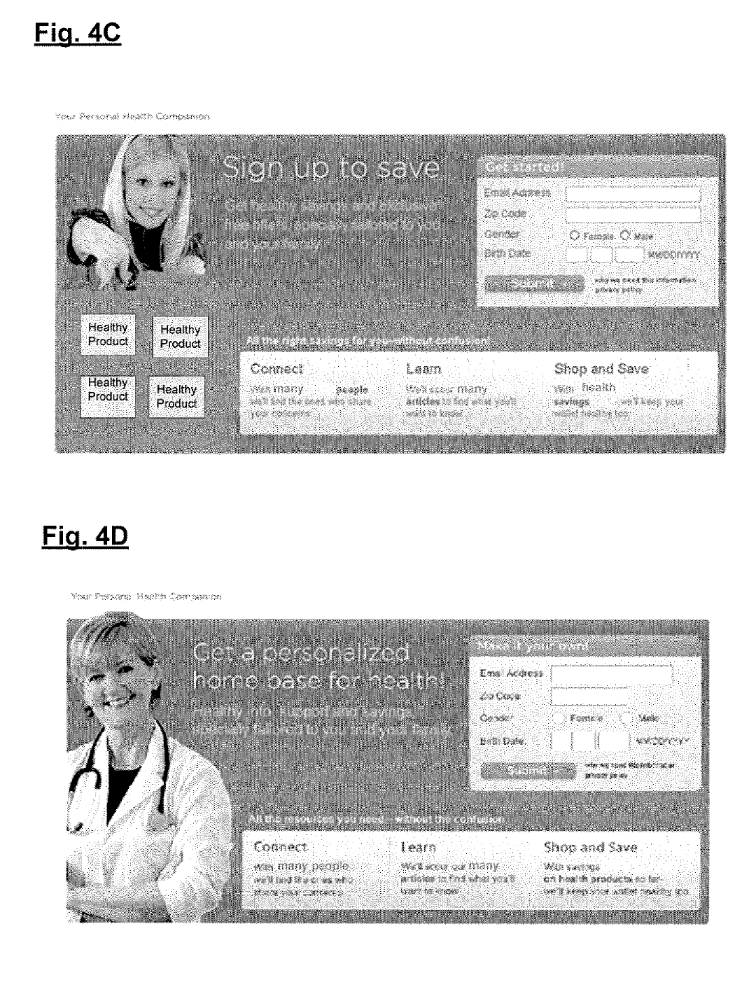

Some of the examples of landing pages are “Simple Save Landing Page with email capture” as illustrated in FIGS. 4A and 4B. This is a simple means to provide the consumer 106 with a free membership registration including some other free incentives by simply submitting his/her e-mail address. Free incentives preferably include, but are not limited to, free samples of health products; coupons and savings of health products; paid surveys on health data; health related news, polls, tips, tools, recipes; health related newsletters and community, etc. Other examples of landing pages are an “Email with Zip and Updated Branding” as illustrated in FIGS. 4C and 4D. This is simply provided to the consumer 106 via an e-mail with a zip and updated branding of the savings and resources. Also included in this landing page is a section prompting the consumer 106 to enter his/her basic personal information such as an e-mail address, zip code, gender, birth date etc. as illustrated in FIG. 4C and FIG. 4D.

The consumer may preferably enter the basic personal information in the landing page and clicks the “submit” icon. This basic personal information is then transmitted from the consumer device 104 via the network 102 and stored in the database 107 as consumer's data profile. Also stored in the database 107 is relevant data which preferably includes, but is not limited to, consumer health conditions and co-morbidities, consumer demographics (personal data), consumer favorites (specific contents, offers and services), the contents viewed by the consumer, content type (e.g., news, medical information, health polls, blogs, community members, ads, newsletters, profiling information, savings and offers etc.), content health conditions and co-morbidities, content rating, content popularity, content recency. The entity server 108 functions to execute the relevant content algorithm such that each combination of PID with ad and data provided on the landing page is analyzed in real time and dynamically changes the landing pages based on the relevant data and the relevant content algorithm. This processing of the PID/ad/landing page leads the entity server 108 to execute a registration page on the consumer's device 104 at step 208. Note that this registration page is unique to each consumer based on the PED/ad/landing page including the changes in the relevant data.

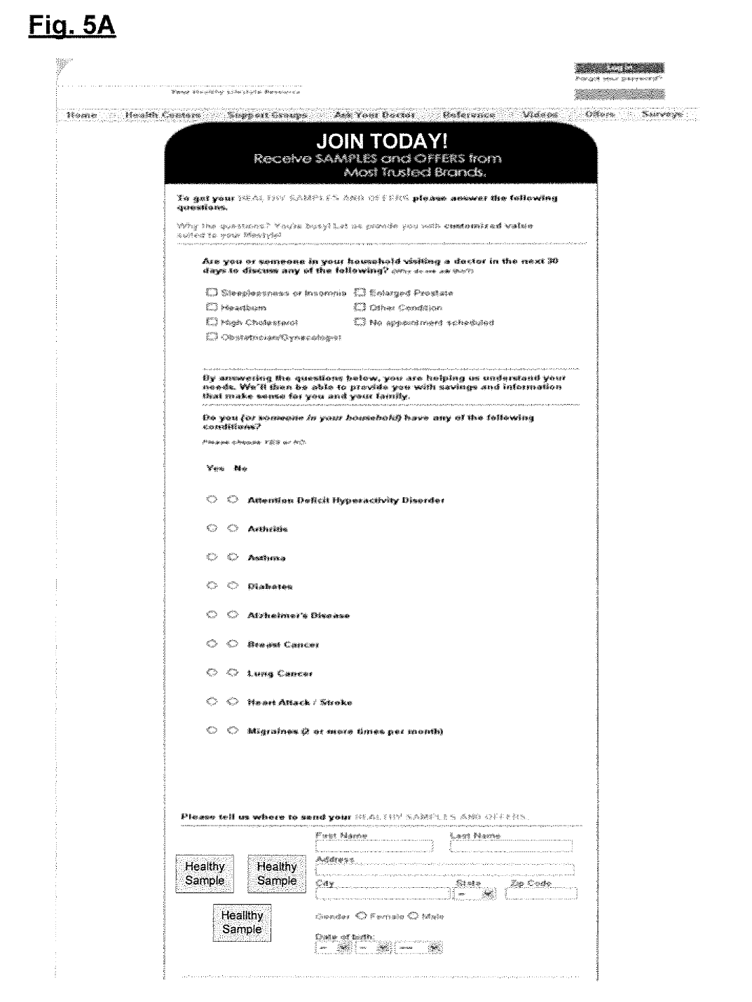

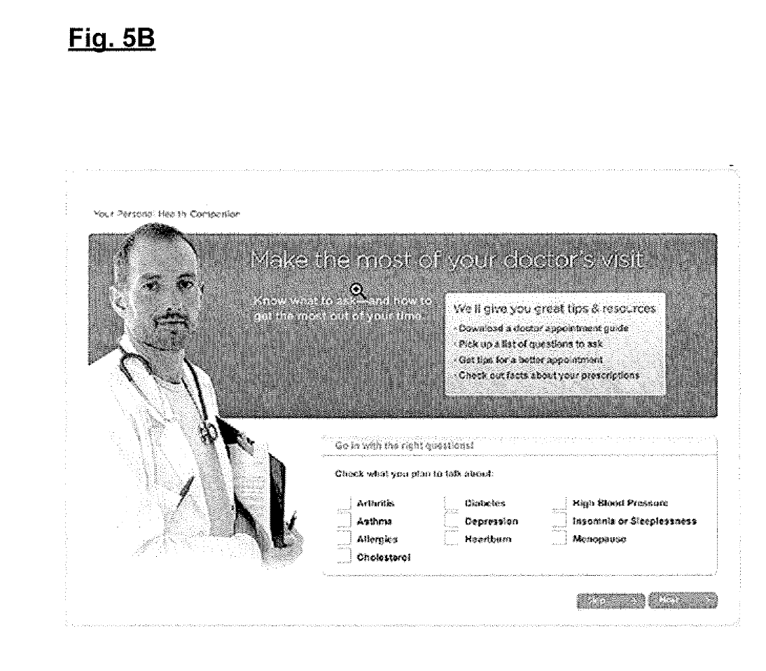

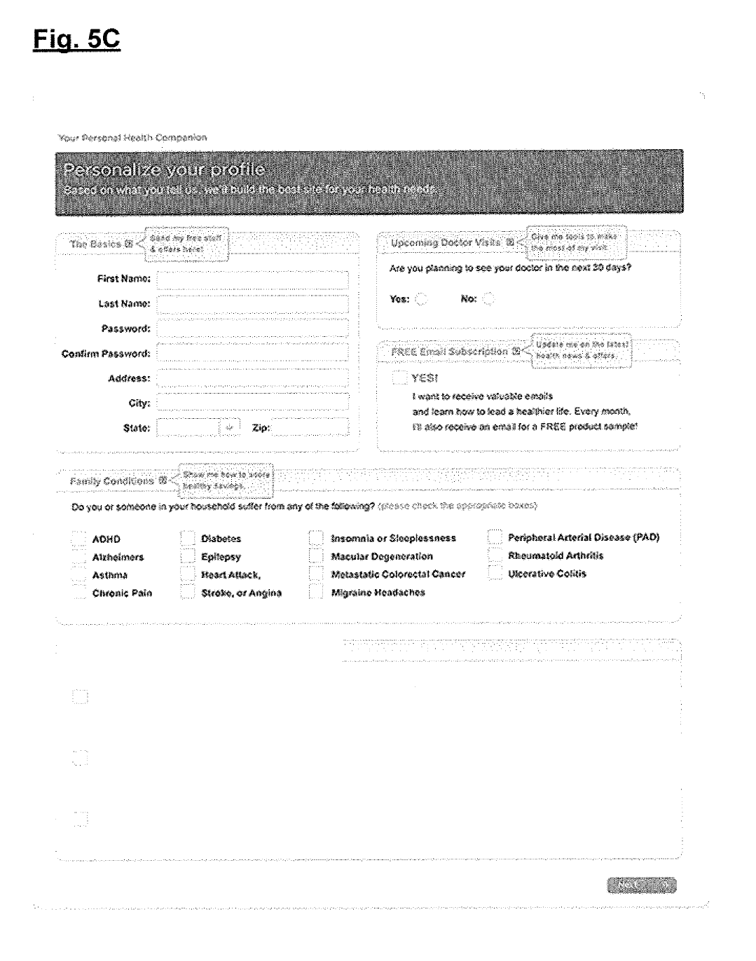

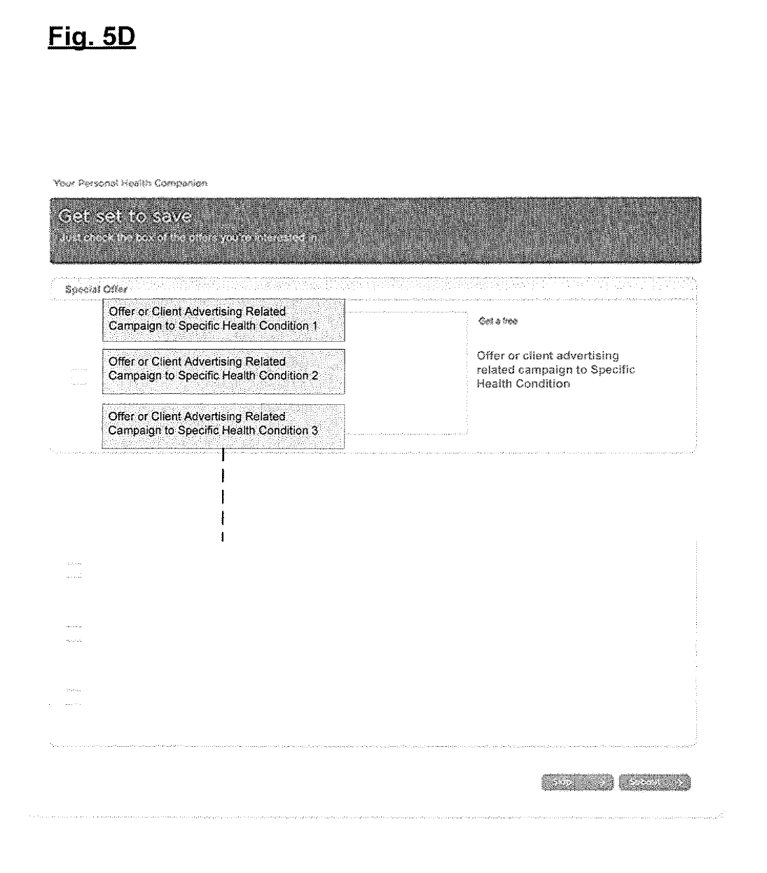

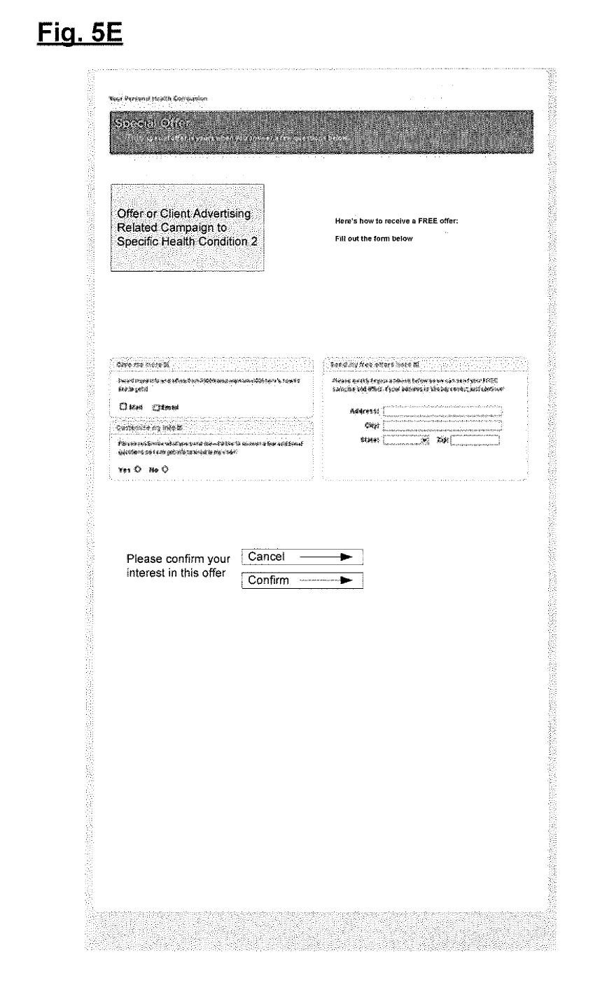

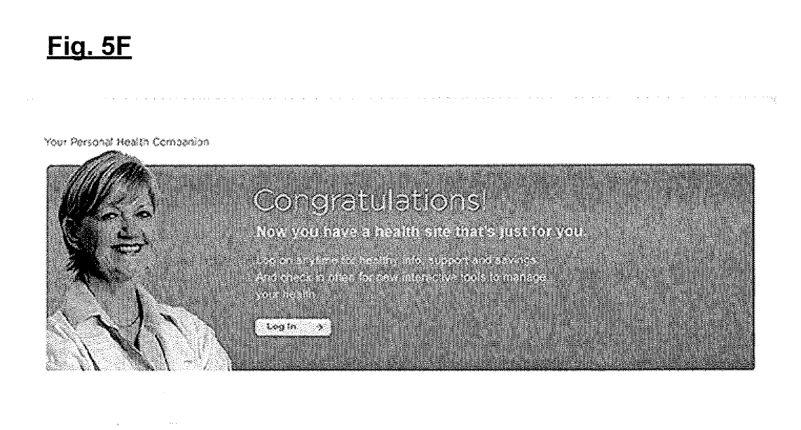

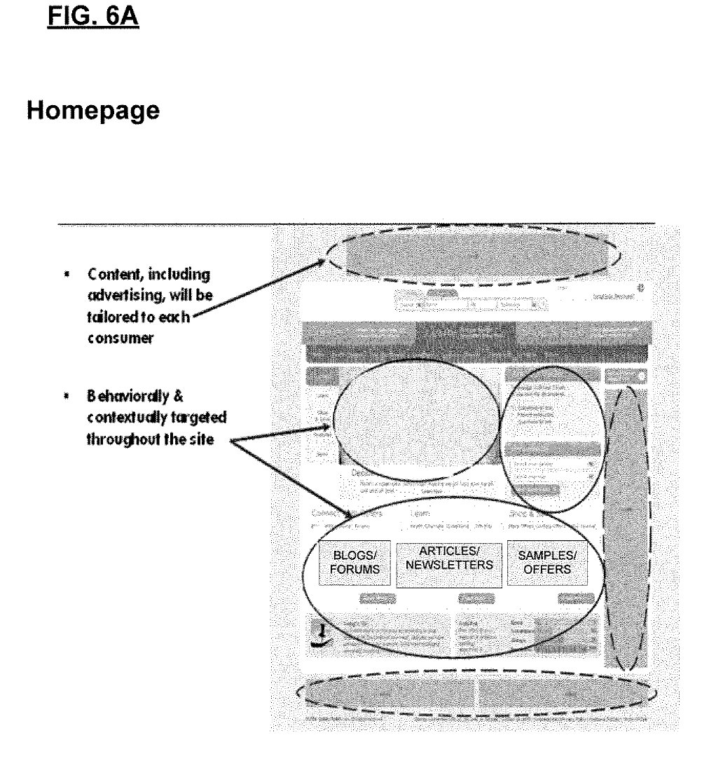

Some examples of the registration pages including healthographic data gathering are illustrated through FIGS. 5A to 5F. An exemplary typical initial registration page is shown in FIG. 5A. Note that if the consumer 106 is already a member of the entity server 108, he/she simply may preferably choose to click on “Log In” icon on this page and will be provided with a page (not shown) to enter their confidentiality information such as a password. Alternatively, a consumer 106 who is already a member may choose to remain in the initial registration page. The initial registration page preferably includes questions related to the health data of the consumer 106 and also the household members of the consumer 106 as shown in FIG. 5A. Some of these questions include, but are not limited to, information on the upcoming visit to a health professional, information on the health conditions, more detailed personal information etc. Additionally, the consumer 106 is provided with some savings offers on this registration page and attracted to receive these offers upon answering the questions as shown in FIG. 5A. Upon answering and/or selecting the answers to the questions, the consumer 106 will preferably click on the icon “Join Today” from its consumer device 104. This information will be immediately transmitted and stored as consumer's data profile in the database of the entity server 108. Note that if the consumer 106 selects the answer of the exemplary question, “Are you or someone in your household visiting a doctor in the next thirty days . . . ”, as shown in FIG. 5A, the entity server 108 will be prompted to execute to communicate/link the next registration page, preferably entitled, “Ask Your Doctor” on the consumer device 104.

An example of an “Ask Your Doctor” page is illustrated in FIG. 5B. Although not shown, the subsequent e-mails and on site content triggered by the positive response to the AYD question includes tips and resources related to health data and a list of health related conditions that the consumer 106 can select which he/she plans to talk to the doctor about in order to prepare the consumer for their upcoming doctor's visit. These subsequent e-mails are generated by the relevant content algorithm based on the positive response the AYD question. Upon choosing the appropriate selection of the condition the consumer plans to discuss with the doctor, the consumer 106 will preferably click on the “submit” icon which will prompt the entity server 108 to execute to link the consumer device 104 to the next registration page, preferably entitled, “Updated Registration—Main Registration”, as illustrated in FIG. 5C. Note that if the consumer does not select the answer of the question, i.e., “Are you or someone in your household visiting a doctor in the next thirty days . . . ”, as shown in FIG. 5, he/she will skip the “Ask Your Doctor” page of FIG. 5B and will be prompted directly to the “Updated Registration—Main registration” page as illustrated in FIG. 5C.

As illustrated in next FIG. 5C, the “Main Registration” page will ask for more detailed personal information of the consumer and a healthographic information of the consumer and members of his/her household to create his/her profile data. Upon entering this information, the consumer 106 will preferably click on the icon “Next” which will store the personal and healthographic information of the consumer as consumer's data profile in the database 107 and prompt the entity server 108 to execute the relevant content algorithm to process the healthographic information of the consumer 106 and link the consumer device 104 with the next registration page entitled, “Updated Registration—Offers/Registration Monetization”.

An example of the “Updated Registration—Offers/Registration Monetization” page is illustrated in the following FIG. 5D. It is important to note that this page comprises specific content tailored to the consumer 106. As discussed above, the specific content to be delivered to the consumer device 104 is generated by the relevant content algorithm based on the healthographic information stored in the consumer's data profile. As illustrated in following FIG. 5D, the page specifically provides the consumer 106 with a special free offer or a client advertisement related campaign to specific health condition targeted to that consumer 106. As illustrated in FIG. 5D, there may preferably be more than one of these offers or client advertisements related campaign to specific health conditions provided to the consumer based on the health related information provided by the consumer in previous screen images of FIGS. 5A, 5B and 5C. For example, if the consumer indicated Diabetes as a condition suffered by him/her and/or member(s) of the household, the page (FIG. 5D) will provide a special offer on the free sample medicine related to “Diabetes” and other client advertisement related campaign such as newsletters, online shopping, online surveys etc., related to “Diabetes”, which are again tailored to the consumer 106 and/or members of his/her household. The consumer 106 may preferably decide not to select any of the offers and click on the “skip” icon. This will preferably lead the consumer device 104 to the next registration page, entitled, “Special Offer Submission” page.

Alternatively, the consumer 106 may select one or more of these offers or client advertisements related campaign to specific health conditions provided in FIG. 5D and click on the “submit” icon, which are then presented to the consumer device 104 in a step-wise manner. Although, not shown, each offer may contain information on what the consumer is signing up for and survey questions to complete. Once, the consumer completes the offer, he/she is presented with an offer specific thank you message and then shown their next offer. After their last offer is completed, the consumer device 104 will be presented with the next registration page, entitled, “Special Offer Submission” page. Note that anytime during the offers, the consumer 106 may wish to click the “skip” icon and will thus be provided with this registration page.

An example of the “Special Offer Submission” page is illustrated in the following FIG. 5E. It is important to note that this page comprises specific content tailored to the consumer 106. As discussed above, the specific content to be delivered to the consumer device 104 is generated by the relevant content algorithm based on the healthographic information stored in the consumer's data profile. As illustrated in following FIG. 5E, the page specifically provides the consumer 106 with a special offer on an exemplary free offer or client advertising related campaign to specific health condition, targeted to that consumer 106 including instructions on how to receive the free sample product. This free offer or client advertising related campaign to specific health condition is only provided to the consumer if he or she chose to select the same on the image shown in FIG. 5D. This page also preferably provides consumers with access to obtain additional information and offers, and to customize the information for that consumer. After completing the information, the consumer may preferably click the “submit” icon, which also leads the consumer to the last registration page, entitled, “Updated Registration—Thank you”. Alternatively, the consumer may preferably skip this page in FIG. 5E and click the “cancel” icon which will lead the consumer device 104 to the last registration page, entitled, “Updated Registration—Thank you”.

An example of this last page is illustrated in FIG. 5F. This page informs the consumer 106 of the completion of the registration process including the fact that the consumer 106 is now a member of a website of the entity server 108 that is preferably designed for his/her health related needs.

It is important to note that the landing and registration pages specific to the consumer are not necessarily generated based only on the consumer answering questions. These pages may also generated by the relevant content algorithm based on the consumer's behavior, for example, reading an article related to a specific health related condition etc.

As discussed above, a lot of information provided by the consumer 106 during registration is retrieved and stored in the database 107 as the relevant data of that consumer. This relevant data is then retrieved from the database 107 in step 209 and processed by the relevant content algorithm of the entity server 108 at step 210, which is referred to as relevant content scoring. Note that each of these relevant data is provided with a score or a value. As an example, each relevant data is represented by a letter such as “A” for consumer health conditions and co-morbidities, “B” for consumer demographics (personal data), “C” for consumer favorites (e.g., specific contents, offers and services), “D” for the contents viewed by the consumer, “E” for the content type (e.g., news, medical information, health polls, blogs, community members, ads, newsletters, profiling information, savings and offers, etc.), “F” for the content health conditions and co-morbidities, “G” for content rating, “H” for content popularity, “I” for content recency. So, a possible relevance score example is an equation: 18*F+8*C+6*A+6*I+3*G+3*H+2*D+J. Note that the numerical values provided to each of these letters (i.e., relevant data) are scores assigned on a scale of 1 to 10 based on the profiling questions answered by the consumer and/or the implied behavior of the consumer. These values are assigned to the relevant data based on the constant cycle of the entity server 108 continuously providing content type(s) to the consumer device. Thus the score is a discreet value that is attached to each piece of content relative to each consumer profile in real time. Other data provided in the exemplary equation above is random weighting (for example, letter “J”), which is if all the relevant data mentioned above have equal value, then one relevant data is randomly chosen.

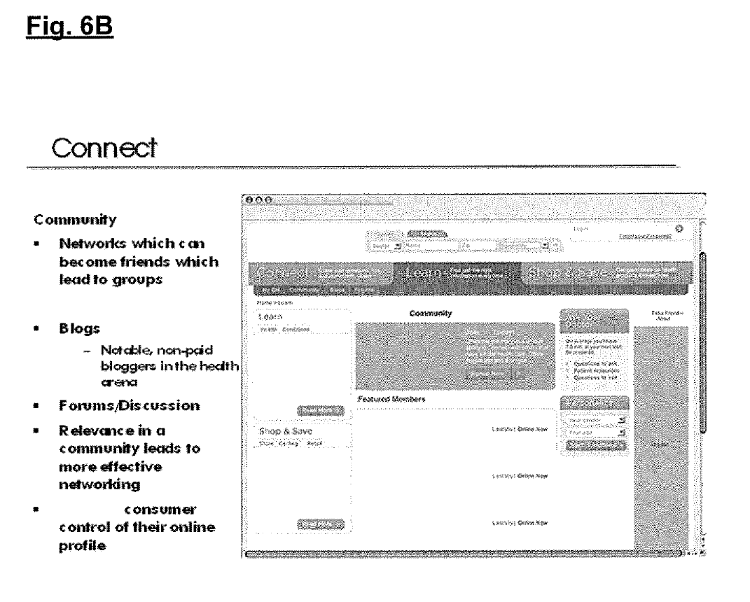

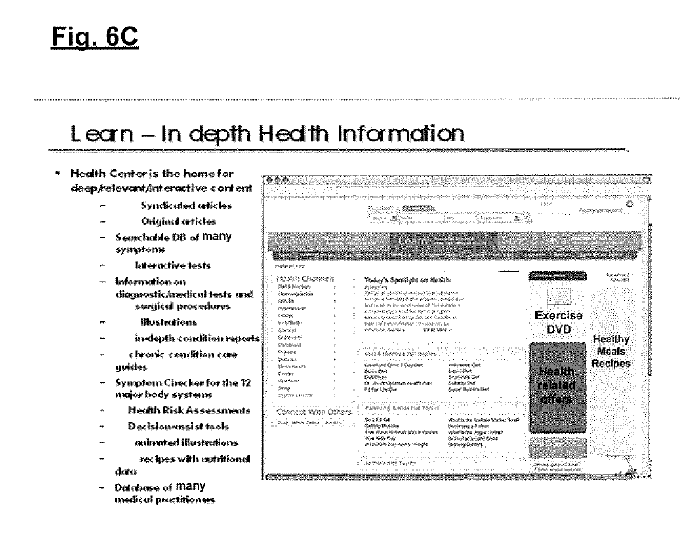

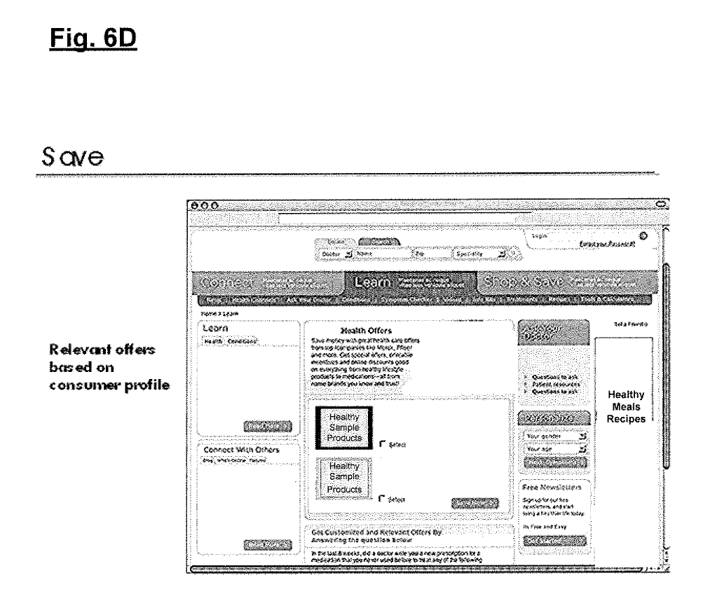

Thus, based on the relevance score of each content type, the relevant content is linked to be presented or displayed on the consumer device 104 by the entity server 108 via the network 102 in step 212. For example, if the relevance scores of the content types such as ads, health tips, articles, are very high for the consumer 106, then that consumer will receive a relevant content page including this relevant data on his/her device. An exemplary relevant content page entitled, “Homepage” as illustrated in FIG. 6A is displayed on the consumer device 104. The contents of this page preferably include several content types targeted for each consumer. One such content type includes advertising, which is tailored to each consumer 106. Another content type displayed on the consumer device 104 is medical information, which includes behaviorally & contextually data targeted to each consumer 106. Further content types include community members, blogs, and savings and offers which are relevant to the consumer 106. Some examples of content types such as community, in-depth health information, savings are illustrated in FIGS. 6B, 6C and 6D respectively. Note that these content types are rendered based on the relevant data and the relevance scores of each content type applicable to the consumer 106.

Upon presenting the relevant content to the consumer at step 212, several steps may be performed by the entity server 108. One of these steps preferably includes executing further healthographic profiling at step 214. In this step, the entity server 108 leverages the relevance scoring to determine the content type of the healthographic profiling question(s) to ask each consumer 106. Based on the scoring equation discussed above, the relevant content algorithm of the entity server 108 executes the healthographic profiling question(s) to be presented to the consumer 106 and preferably displays these profiling question(s) to the consumer on his/her device 104. Note that these profiling questions are tailored to each consumer 106. The consumer 106 preferably provides his/her responses to these profiling questions. Upon receiving these responses from the consumer 106, the entity server 108 executes the relevant content algorithm to further update relevant content scoring in step 210 as shown by the feedback loop from step 214 to step 210. Based on this updated relevant content scoring, the relevant content is linked to be again presented or displayed on the consumer device 104 by the entity server 108 via the network 102 on step 212. Then, preferably, further healthographic profiling is again executed at step 214 and thus the feedback loop continues again from step 214 to 210 as discussed above. Thus, this is an ongoing real-time continuous process.

The relevant content algorithm further layers out several conclusions based on the further healthographic profiling questions answered by the consumer 106. Some of these conclusions include, but are not limited to, completion rate, i.e., percentage of consumers who complete the profiling questions, qualification rate, i.e., percentage of consumers who qualify for an advertisement (ad) after answering the profiling question(s), and advertisement revenue, i.e., the amount of money associated ad(s) will generate when shown to a qualified consumer. Based on this information the entity server 108 then seeks to benefit the consumer by presenting the most relevant content, savings offers and advertisements to them. This saves consumers time by making each interaction with the website more and more focused on them and the health issues that they are interested or should be aware of surrounding their healthographic profile.

Furthermore, as illustrated in FIG. 2, after presentation of the relevant content to the consumer 106 at step 212, retention of personalized e-mail is preferably executed by the entity server 108 at regular intervals, at step 216. In this step, the entity server 108 leverages the relevance scoring to determine the e-mail content relevant to the consumer 106. The entity server 108 executes the personalized retention e-mail to the consumer 106 on his/her consumer device 104. Note that these e-mails are personalized to each consumer 106. Upon receiving either the behavioral response or answers the questions via the personalized retention e-mail from the consumer, the entity server 108 executes the relevant content algorithm to further update relevant content scoring in step 210 as shown by the feedback loop from step 216 to step 210. Based on this updated relevant content scoring, the relevant content is linked to be again presented or displayed on the consumer device 104 by the entity server 108 via the network 102 on step 212. Then, preferably, the dynamic personalized retention e-mail is executed again at step 216 and thus the feedback loop continues again from step 216 to 210 as discussed above. Thus, this is an ongoing real-time continuous process.

The relevant content algorithm further layers out several conclusions based on the behavioral response or answers the questions via the personalized retention e-mail from the consumer 106. Some conclusions include, but are not limited to, complaint rate, i.e., percentage of consumers who mark the e-mail as SPAM, open rate, i.e., percentage of consumers who open the e-mail, click rate, i.e., the percentage of consumers who visit the site of the entity server 108 by clicking on a link in the e-mail and revenue/consumer, i.e., amount of revenue made for each other consumer driven to the site of the entity server 108. Based on this information the entity server 108 and system 101 may preferably alter the contents, savings offers, and advertisement of future emails. In addition the system 101 may also preferably alter the frequency, layout, subject lines, and delivery time of future emails.

Although, not shown, the relevant content algorithm leverages the MARC relevancy scoring for the advertisement and layers in for targeted CPA and CPM offers. Some of the targeted CPA offers include, but are not limited to CPA, i.e., amount of dollars made for a qualified consumer completing the offer survey; Take Rate, i.e., percentage of consumers who complete the CPA offer survey after qualifying for it; and Penetration, i.e., percentage of consumers who qualify for the CPA offer. Some of the targeted CPM offers include, and are not limited to CPM, i.e., amount of dollars made for a qualified consumer viewing the advertisement; Click Rate, i.e., percentage of consumers who click the CPM advertisement.

The aspect of the algorithm as discussed above, with respect toe the CPA and CPM, has a heavy feedback loop component. To further optimize, the customers are then segmented by not only the traditional demographic information, but also the source. The source can be any one of thousands of media partners, or retention emails, or search engine traffic, or any of a variety of other sources. This segmentation adds an additional optimization dimension by skewing specific advertisements towards specific consumer types from specific sources. Note that the profiling question algorithm also leverages this data.

It is to be understood that the exemplary embodiments are merely illustrative of the invention and many variations of the above-described embodiments can be devised by one skilled in the art without departing from the scope of the invention. It is therefore intended that all such variations be included within the scope of the following claims and their equivalents.

What is claimed:

1. A system for communicating targeted health related data comprising:
a. an entity server comprising a database;
b. a source server associated with a source of health related data which is transmitted to the entity server;
c. a consumer device which transmits personal information to, and receives health related data from, the entity server;
wherein the entity server assigns a score to the personal information received from the consumer device and transmits health related data to the consumer device depending on the score assigned.

2. The system of claim 1, wherein the health related data is selected from the group consisting of:
savings on products or services, advertisements, information on health related conditions, articles, recipes, information on health care professional, and combinations thereof.

3. The system of claim 1, wherein the entity server assigns a publisher identification to each of the sources of health related data associated with the source server.

4. The system of claim 1, wherein the database stores information transmitted from the consumer device.

5. The system of claim 4, wherein the information transmitted from the consumer device is a consumer data profile.

6. The system of claim 5, wherein the consumer data profile contains information selected from the group consisting of a consumer name, a consumer mailing address, a consumer e-mail address, a consumer healthographic profile, a consumer transaction history, and combinations thereof.

7. The system of claim 1, wherein score is calculated by a relevant content algorithm.

8. A method for communicating health related data to a consumer comprising:
a. providing the consumer with access to a entity server via a consumer device;
b. gathering personal information from the consumer in the entity server;
c. gathering health related data from a source server;
d. assigning a score to the personal information;
e. providing health related information to the consumer determined by the score assigned to the personal information.

9. The method of claim 8, wherein the type of health related data transmitted is determined by the score assigned to the personal information.

10. The method of claim 9, wherein the health related data is selected from the group consisting of:
savings on products or services, advertisements, information on health related conditions, articles, recipes, information on health care professional, and combinations thereof.

11. The method of claim 8, wherein the source server is associated with a source of health related data.

12. The method of claim 11, wherein the source of health related date is assigned a publisher identification.

13. The method of claim 8, wherein the database stores information transmitted from the consumer device.

14. The method of claim 8, wherein the database stores the health related data transmitted from the source server.

15. The method of claim 8, wherein the information transmitted from the consumer device is a consumer data profile.

16. The method of claim 8, wherein the consumer data profile contains information selected from the group consisting of a consumer name, a consumer mailing address, a consumer e-mail address, a consumer healthographic profile, a consumer transaction history, and combinations thereof.

17. The method of claim 8, wherein the score is calculated by a relevant content algorithm.

18. The method of claim 1, wherein steps b-e are performed as a continuous process.

19. A system for communicating targeted health related data comprising:
a. an entity server comprising a database;
b. a source server associated with a source of health related data which is transmitted to the entity server, wherein the health related data is selected from the group consisting of: savings on products or services, advertisements, information on health related conditions, articles, recipes, information on health care professional, and combinations thereof;
c. a consumer device which transmits personal information to, and receives health related data from, the entity server;
wherein the entity server assigns a score to the personal information received from the consumer device and transmits health related data to the consumer device depending on the score assigned.

20. The system of claim 19, wherein the consumer data profile contains information selected from the group consisting of a consumer name, a consumer mailing address, a consumer e-mail address, a consumer healthographic profile, a consumer transaction history, and combinations thereof.
